(19) United States
(12) Patent Application Publication
(10) Pub. No.: US 2016/0079632 A1
(43) Pub. Date: Mar. 17, 2016

(54) MOLTEN-SALT ELECTROLYTE AND SODIUM MOLTEN-SALT BATTERY

(71) Applicant: SUMITOMO ELECTRIC INDUSTRIES, LTD., Osaka-shi (JP)

(72) Inventors: Atsushi Fukunaga, Osaka-shi (JP); Shinji Inazawa, Osaka-shi (JP); Koji Nitta, Osaka-shi (JP); Shoichiro Sakai, Osaka-shi (JP); Eiko Imazaki, Osaka-shi (JP); Koma Numata, Osaka-shi (JP)

(21) Appl. No.: 14/784,885

(22) PCT Filed: Mar. 3, 2014
(86) PCT No.: PCT/JP2014/055221

§ 371 Date: Oct. 15, 2015

(30) Foreign Application Priority Data
Apr. 19, 2013 (JP) 2013-088582

(51) Int. Cl. H01M 10/39

(52) U.S. Cl. CPC H01M 10/399; H01M 2300/0048

(57) ABSTRACT

Provided are a molten-salt electrolyte having good charge-discharge cycle characteristics and a sodium molten-salt battery using the same. The molten-salt electrolyte contains an ionic liquid whose ultraviolet-visible absorption spectrum does not have an absorption peak attributable to impurities in a wavelength range of 200 to 500 nm, and a sodium salt. The sodium molten-salt battery includes a positive electrode that contains a positive electrode active material, a negative electrode that contains a negative electrode active material, and the molten-salt electrolyte. The ionic liquid is preferably a salt of an organic onium cation and a bis(sulfonyl)imide anion.

### TECHNICAL FIELD

The present invention relates to a molten-salt electrolyte having sodium ion conductivity, and a sodium molten-salt battery that includes the molten-salt electrolyte. In particular, the present invention relates to an improvement of a molten-salt electrolyte.

### BACKGROUND ART

In recent years, the demand for non-aqueous electrolyte secondary batteries has been increasing as high-energy density batteries that can store electrical energy. Among non-aqueous electrolyte secondary batteries, molten-salt batteries that use flame-retardant molten-salt electrolytes are advantageous in terms of good thermal stability. In particular, sodium molten-salt batteries that use molten-salt electrolytes having sodium ion conductivity can be produced from inexpensive raw materials and thus are regarded as promising next-generation secondary batteries.

Promising molten-salt electrolytes are ionic liquids which are salts of organic cations and organic anions (refer to PTL 1). However, the history of the development of ionic liquids is short, and ionic liquids containing various minor components as impurities are used at present.

It is becoming clear that, among impurities contained in ionic liquids, moisture significantly affects charge-discharge characteristics and storage characteristics of molten-salt batteries. Therefore, removing moisture from ionic liquids by, for example, a method of drying under reduced pressure has been proposed. On the other hand, there have been few studies on the effects of impurities other than moisture on molten-salt batteries, and this is an unexplored area.

### CITATION LIST

### Patent Literature

### PTL 1: Japanese Unexamined Patent Application Publication No. 2006-196390

### SUMMARY OF INVENTION

### Technical Problem

When a charge-discharge cycle of a sodium molten-salt battery is repeated, a decrease in the charge-discharge capacity, the decrease being believed to be caused by impurities of an ionic liquid, is observed. Furthermore, even in a case of using an ionic liquid from which impurities are not detected by inductively coupled plasma (ICP) analysis, ion chromatography, infrared spectroscopic analysis (IR analysis), nuclear magnetic resonance (NMR) analysis, or the like, a decrease in the charge-discharge capacity is observed. In order to suppress such a decrease in the charge-discharge capacity (decrease in the capacity retention rate), it is necessary to identify impurities by another analytical method and to remove the impurities from the ionic liquid.

### Solution to Problem

In view of the circumstances described above, the inventors of the present invention analyzed various ionic liquids by various methods and evaluated charge-discharge cycle characteristics of molten-salt batteries including the analyzed ionic liquids. As a result, it was found that the charge-discharge cycle characteristics significantly change with a change in an ultraviolet-visible absorption spectrum (UV-Vis absorption spectrum). The change in the charge-discharge cycle characteristics can be confirmed by only a slight change in the UV-Vis absorption spectrum. The present invention has been achieved on the basis of the above finding.

Specifically, an aspect of the present invention relates to a molten-salt electrolyte containing an ionic liquid whose UV-Vis absorption spectrum does not have an absorption peak attributable to impurities in a wavelength range of 200 nm or more and 500 nm or less, and a sodium salt.

Furthermore, another aspect of the present invention relates to a sodium molten-salt battery including a positive electrode that contains a positive electrode active material, a negative electrode that contains a negative electrode active material, and the above molten-salt electrolyte.

### Advantageous Effects of Invention

According to the present invention, it is possible to suppress a decrease in the capacity retention rate during charge-discharge cycles of a sodium molten-salt battery, the decrease being caused by impurities contained in an ionic liquid.

### BRIEF DESCRIPTION OF DRAWINGS

FIG. 1 is a front view of a positive electrode according to an embodiment of the present invention.

FIG. 2 is a cross-sectional view taken along line II-II in FIG. 1.

FIG. 3 is a front view of a negative electrode according to an embodiment of the present invention.

FIG. 4 is a cross-sectional view taken along line IV-IV in FIG. 3.

FIG. 5 is a perspective view of a molten-salt battery according to an embodiment of the present invention, in which a battery case is partially cut out.

FIG. 6 is a schematic longitudinal cross-sectional view taken along line VI-VI in FIG. 5.

FIG. 7 includes ultraviolet-visible absorption spectra of ionic liquids according to Example and Comparative Example.

FIG. 8 is a graph showing the relationship between the capacity retention rate and the number of charge-discharge cycles of sodium molten-salt batteries according to Example and Comparative Example.

### DESCRIPTION OF EMBODIMENTS

### Description of Embodiments of Invention

First, the contents of embodiments of the present invention will be listed and described.

An aspect of the present invention relates to a molten-salt electrolyte containing an ionic liquid whose ultraviolet-visible absorption spectrum does not have an absorption peak attributable to impurities in a wavelength range of 200 nm or more and 500 nm or less, and a sodium salt.

It was found that, even in an ionic liquid from which impurities are not detected by ICP analysis, ion chromatography, IR analysis, NMR analysis, or the like, when a UV-Vis absorption spectrum of the ionic liquid is measured, a peak attributable to impurities is observed in the wavelength range of 200 to 500 nm, in particular, 200 to 300 nm. On the other hand, it was also found that after an ionic liquid has been treated with an adsorbent or a molecular sieve material, such as activated carbon, activated alumina, zeolite, or a molecular sieve, a peak in the wavelength range of 200 to 500 nm is not observed. Furthermore, it was also found that the use of a molten-salt electrolyte whose UV-Vis absorption spectrum does not have an absorption peak attributable to impurities in the wavelength range of 200 to 500 nm improves charge-discharge cycle characteristics of a sodium molten-salt battery.

The amount of impurities that exhibit a peak in the wavelength range of 200 to 500 nm is very small, and it is difficult to identify the impurities. Accordingly, a clear conclusion concerning the attribution of impurities has not been obtained to date. However, it is believed that the impurities are mixed in a very small amount when an ionic liquid is produced industrially.

The ionic liquid is preferably a salt of an organic onium cation and a bis(sulfonyl)imide anion. Impurities that exhibit a peak in the wavelength range of 200 to 500 nm are contained in a relatively large amount in an ionic liquid that contains an organic onium cation. Accordingly, the effect obtained by removing impurities that exhibit a peak in the wavelength range of 200 to 500 nm, for example, the effect of a treatment with an adsorbent becomes significant when an ionic liquid that contains an organic onium cation is used. Furthermore, the use of a bis(sulfonyl)imide anion can provide a molten-salt electrolyte having high heat resistance and high ion conductivity.

Herein, the organic onium cation is preferably an organic onium cation having a nitrogen-containing heterocycle. Ionic liquids that contain an organic onium cation having a nitrogen-containing heterocycle have high heat resistance and a low viscosity and thus are promising as molten-salt electrolytes. Among organic onium cations having a nitrogen-containing heterocycle, organic onium cations having a pyrrolidine skeleton have a particularly high heat resistance, and the production cost thereof is low. Thus, organic onium cations having a pyrrolidine skeleton are promising as molten-salt electrolytes.

The sodium salt dissolved in the ionic liquid is preferably a salt of a sodium ion and a bis(sulfonyl)imide anion. By using a bis(sulfonyl)imide anion, a molten-salt electrolyte having high heat resistance and high ion conductivity can be obtained.

Another aspect of the present invention relates to a sodium molten-salt battery including a positive electrode that contains a positive electrode active material, a negative electrode that contains a negative electrode active material, and the molten-salt electrolyte described above.

The positive electrode active material is a material that electrochemically intercalates and deintercalates sodium ions. The negative electrode active material may be a material that electrochemically intercalates and deintercalates sodium ions and may be metallic sodium, a sodium alloy (such as Na—Sn alloy), or a metal (such as Sn) that alloys with sodium.

As the positive electrode active material, a compound represented by a general formula: Na₁₋ₓM¹ₓCr_{1-y}M²_{y}O₂ (where 0≦x≦⅔, 0≦y≦0.7, and M¹ and M² are each independently a metal element other than Cr and Na) is preferably used. Such a compound can be produced at a low cost and has good reversibility of the structural change that occurs during charging and discharging. Accordingly, a sodium molten-salt battery having better charge-discharge cycle characteristics can be obtained.

### [Details of Embodiments of Invention]

Next, details of embodiments of the present invention will be described.

The molten-salt electrolyte and components of the sodium molten-salt battery will now be described in detail.

### [Molten-Salt Electrolyte]

The molten-salt electrolyte contains a sodium salt and an ionic liquid that dissolves the sodium salt therein.

The molten-salt electrolyte is a liquid in an operational temperature range of the sodium molten-salt battery. The sodium salt corresponds to a solute of the molten-salt electrolyte. The ionic liquid functions as a solvent that dissolves the sodium salt therein.

The molten-salt electrolyte has an advantage in that it has high heat resistance and has incombustibility. Accordingly, it is desirable that the molten-salt electrolyte contain as small an amount of a component other than a sodium salt and an ionic liquid as possible. However, additives may be incorporated in the molten-salt electrolyte in an amount that does not significantly impair heat resistance and incombustibility. So as not to impair heat resistance and incombustibility, the sodium salt and the ionic liquid account for preferably 90% to 100% by mass, and more preferably 95% to 100% by mass of the molten-salt electrolyte.

It is believed that impurities that exhibit a peak in a wavelength range of 200 to 500 nm are contained in various ionic liquids that are industrially produced. On the other hand, an absorption peak attributable to impurities in the wavelength range of 200 to 500 nm is eliminated from a UV-Vis absorption spectrum of an ionic liquid by highly purifying the ionic liquid with an adsorbent such as activated carbon, activated alumina, zeolite, or a molecular sieve. The use of such an ionic liquid can provide a molten-salt electrolyte that does not have an absorption peak attributable to impurities in the wavelength range of 200 to 500 nm. The method for removing impurities from an ionic liquid is not particularly limited. For example, an ionic liquid may be purified by a recrystallization method or the like. Alternatively, a molten-salt electrolyte which is a mixture of a sodium salt and an ionic liquid may be purified with an adsorbent.

In general, adsorbents such as activated carbon, activated alumina, zeolite, and a molecular sieve contain an alkali metal such as potassium or sodium. Accordingly, an ionic liquid that has been passed through an adsorbent cannot be used in lithium molten-salt batteries or lithium ion secondary batteries. This is because charge-discharge characteristics of lithium ion secondary batteries significantly degrade if alkali metal ions such as potassium ions or sodium ions are eluted in the ionic liquid. For example, since the oxidation-reduction potentials of sodium and potassium are higher than that of lithium, a battery reaction of lithium ions is inhibited. In contrast, since a sodium molten-salt battery originally contains sodium ions, charge-discharge characteristics of the sodium molten-salt battery do not degrade. In addition, the oxidation-reduction potential of sodium is higher than that of potassium, and thus potassium does not significantly affect charge-discharge characteristics of a sodium molten-salt battery.

The presence or absence of an absorption peak in the wavelength range of 200 to 500 nm in a UV-Vis absorption spectrum is often apparent from the observation of the UV-Vis absorption spectrum. However, even in the case where impurities are contained to the extent that charge-discharge characteristics are negligibly affected, it should be assumed that, in fact, a UV-Vis absorption spectrum does not have an absorption peak. For example, in the case where a UV-Vis absorption spectrum shows a peak having a height equal to or lower than an intensity (height from a base line) I_{NO3} of a peak of pure water that contains 50 ppm of a nitrate ion in a mass ratio, the peak appearing near the range of 200 to 250 nm, it is assumed that, in fact, the absorption spectrum does not have an absorption peak attributable to impurities in the range of 200 to 500 nm.

In addition, in the case where a UV-Vis absorption spectrum of a molten-salt electrolyte is measured by using a commercially available measuring device and the absorbance is less than 0.02 over the entire wavelength range of 200 to 500 nm, it is determined that the absorption spectrum does not have an absorption peak. The sensitivity of the absorbance somewhat varies depending on the measurement device. However, when the absorbance is less than 0.02 regardless of the measurement device, the impurity concentration is sufficiently low and thus charge-discharge characteristics are negligibly affected.

A sodium ion concentration (which is the same as the concentration of a sodium salt when the sodium salt is a monovalent salt) in the molten-salt electrolyte is preferably 2% by mole or more, more preferably 5% by mole or more, and particularly preferably 8% by mole or more of a cation contained in the molten-salt electrolyte. Such a molten-salt electrolyte has good sodium ion conductivity and easily achieves a high capacity even in the case where charging and discharging are performed with a current with a high rate. The sodium ion concentration is preferably 30% by mole or less, more preferably 20% by mole or less, and particularly preferably 15% by mole or less of the cation contained in the molten-salt electrolyte.

Such a molten-salt electrolyte has a high content of an ionic liquid, has a low viscosity, and easily achieves a high capacity even in the case where charging and discharging are performed with a current with a high rate. The preferred upper limit and the preferred lower limit of the sodium ion concentration may be appropriately combined to determine a preferred range. For example, a preferred range of the sodium ion concentration may be 2% to 20% by mole or 5% to 15% by mole.

The sodium salt dissolved in the ionic liquid may be a salt of a sodium ion and an anion such as a borate anion, a phosphate anion, or an imide anion. An example of the borate anion is a tetrafluoroborate anion. An example of the phosphate anion is a hexafluorophosphate anion. An example of the imide anion is a bis(sulfonyl)imide anion. However, the anions are not limited thereto. Among these, a salt of a sodium ion and a bis(sulfonyl)imide anion is preferable. By using a bis(sulfonyl)imide anion, a molten-salt electrolyte having high heat resistance and high ion conductivity can be obtained.

Ionic liquids are liquid salts constituted by a cation and an anion. Among ionic liquids, salts of an organic onium cation and a bis(sulfonyl)imide anion are preferable in terms of high heat resistance and a low viscosity. However, impurities that exhibit a peak in the wavelength range of 200 to 500 nm are contained in a relatively large amount in an ionic liquid that contains an organic onium cation.

Examples of the organic onium cation include cations derived from an aliphatic amine, an alicyclic amine, or an aromatic amine (e.g., quaternary ammonium cations); nitrogen-containing onium cations such as organic onium cations having a nitrogen-containing heterocycle (i.e., cations derived from a cyclic amine); sulfur-containing onium cations; and phosphorus-containing onium cations.

Examples of the quaternary ammonium cation include tetraalkylammonium cations (tetraC₁₋₁₀alkylammonium cations) such as a tetramethylammonium cation, a hexyltrimethylammonium cation, an ethyltrimethylammonium cation (TEA⁺), and a methyltriethylammonium cation (TEMA⁺).

Examples of the sulfur-containing onium cation include tertiary sulfonium cations, such as trialkylsulfonium cations (e.g., triC₁₋₁₀alkylsulfonium cations), namely, a trimethylsulfonium cation, a trihexylsulfonium cation, and a dibutylethylsulfonium cation.

Examples of the phosphorus-containing onium cation include quaternary phosphonium cations such as tetraalkylphosphonium cations (e.g., tetraC₁₋₁₀alkylphosphonium cations), namely, a tetramethylphosphonium cation, a tetraethylphosphonium cation, and a tetraoctylphosphonium cation; and alkyl(alkoxyalkyl)phosphonium cations (e.g., triC₁₋₁₀alkyl(C₁₋₅alkoxyC₁₋₅alkyl)phosphonium cations), namely, a triethyl(methoxymethyl)phosphonium cation, a diethylmethyl(methoxymethyl)phosphonium cation, and a trihexyl(methoxyethyl)phosphonium cation. In the alkyl(alkoxyalkyl)phosphonium cations, the total number of alkyl groups and alkoxyalkyl groups that bond to a phosphorus atom is 4, and the number of alkoxyalkyl groups is preferably 1 or 2.

The number of carbon atoms of an alkyl group that bonds to a nitrogen atom of the quaternary ammonium cation, a sulfur atom of the tertiary sulfonium cation, or a phosphorus atom of the quaternary phosphonium cation is preferably 1 to 8, more preferably 1 to 4, and particularly preferably 1, 2, or 3.

Examples of the nitrogen-containing heterocycle skeleton of the organic onium cation include five- to eight-membered heterocycles that have one or two nitrogen atoms as atoms constituting the ring, such as pyrrolidine, imidazoline, imidazole, pyridine, and piperidine; and five- to eight-membered heterocycles that have one or two nitrogen atoms and other heteroatoms (e.g., oxygen atom and sulfur atom) as atoms constituting the ring, such as morpholine.

The nitrogen atoms which are atoms constituting the ring may have an organic group such as an alkyl group as a substituent. Examples of the alkyl group include alkyl groups having 1 to 10 carbon atoms, such as a methyl group, an ethyl group, a propyl group, and an isopropyl group. The number of carbon atoms of the alkyl group is preferably 1 to 8, more preferably 1 to 4, and particularly preferably 1, 2, or 3.

Besides the quaternary ammonium cations, nitrogen-containing organic onium cations including pyrrolidine, pyridine, or imidazoline as a nitrogen-containing heterocycle skeleton are particularly preferable. The organic onium cation having a pyrrolidine skeleton preferably has two of the above-mentioned alkyl groups on one nitrogen atom constituting a pyrrolidine ring. The organic onium cation having a pyridine skeleton preferably has one of the above-mentioned alkyl groups on one nitrogen atom constituting a pyridine ring. The organic onium cation having an imidazoline skeleton preferably has one of the above-mentioned alkyl groups on each of two nitrogen atoms constituting an imidazoline ring.

Specific examples of the organic onium cation having a pyrrolidine skeleton include a 1,1-dimethylpyrrolidinium cation, a 1,1-diethylpyrrolidinium cation, a 1-ethyl-1-methylpyrrolidinium cation, a 1-methyl-1-propylpyrrolidinium cation (MPPY⁺), a 1-methyl-1-butylpyrrolidinium cation (MBPY⁺), and a 1-ethyl-1-propylpyrrolidinium cation. Among these, in particular, pyrrolidinium cations having a methyl group and an alkyl group with 2 to 4 carbon atoms, such as MPPY⁺ and MBPY⁺, are preferable in view of high electrochemical stability.

Specific examples of the organic onium cation having a pyridine skeleton include 1-alkylpyridinium cations such as a 1-methylpyridinium cation, a 1-ethylpyridinium cation, and a 1-propylpyridinium cation. Among these, pyridinium cations having an alkyl group with 1 to 4 carbon atoms are preferable.

Specific examples of the organic onium cation having an imidazoline skeleton include a 1,3-dimethylimidazolium cation, a 1-ethyl-3-methylimidazolium cation (EMI⁺), a 1-methyl-3-propylimidazolium cation, a 1-butyl-3-methylimidazolium cation (BMI⁺), a 1-ethyl-3-propylimidazolium cation, and a 1-butyl-3-ethylimidazolium cation. Among these, imidazolium cations having a methyl group and an alkyl group with 2 to 4 carbon atoms, such as EMI⁺ and BMI⁺, are preferable.

The ionic liquid may contain one of the above cations or two or more of the above cations. The ionic liquid may contain a salt of a cation of an alkali metal other than sodium and an anion such as a bis(sulfonyl)imide anion. Examples of the cation of an alkali metal include cations of potassium, lithium, rubidium, and cesium. Among these, potassium is preferable.

Examples of the bis(sulfonyl)imide anion constituting an anion of the ionic liquid or the sodium salt include a bis(fluorosulfonyl)imide anion [(N(SO₂F)₂⁻)], (fluorosulfonyl)(perfluoroalkylsulfonyl)imide anions [such as a (fluorosulfonyl)(trifluoromethylsulfonyl)imide anion ((FSO₂)(CF₃SO₂)N⁻)], and bis(perfluoroalkylsulfonyl)imide anions [such as a bis(trifluoromethylsulfonyl)imide anion (N(SO₂CF₃)₂⁻) and a bis(pentafluoroethylsulfonyl)imide anion (N(SO₂C₂F₅)₂⁺]. The number of carbon atoms of the perfluoroalkyl group is, for example, 1 to 10, preferably 1 to 8, more preferably 1 to 4, and, in particular, 1, 2, or 3. These anions may be used alone or in combination of two or more anions.

Among the bis(sulfonyl)imide anions, a bis(fluorosulfonyl)imide anion (FSI⁻); bis(perfluoroalkylsulfonyl)imide anions such as a bis(trifluoromethylsulfonyl)imide anion (TFSI⁻), a bis(pentafluoroethylsulfonyl)imide anion (PFSI⁻), and a (fluorosulfonyl)(trifluoromethylsulfonyl)imide anion; and the like are preferable.

Specific examples of the molten-salt electrolyte includes a molten-salt electrolyte containing a salt of a sodium ion and FSI⁻ (Na.FSI) as a sodium salt and a salt of MPPY⁺ and FSI⁻ (MPPY.FSI) as an ionic liquid, and a molten-salt electrolyte containing a salt of a sodium ion and TFSI⁻ (Na.TFSI) as a sodium salt and a salt of MPPY⁺ and TFSI⁻ (MPPY.TFSI) as an ionic liquid.

In view of the balance of the melting point, viscosity, and ion conductivity of the molten-salt electrolyte, a molar ratio of a sodium salt to an ionic liquid (sodium salt/ionic liquid) is, for example, 98/2 to 80/20, and preferably 95/5 to 85/15.

### [Positive Electrode]

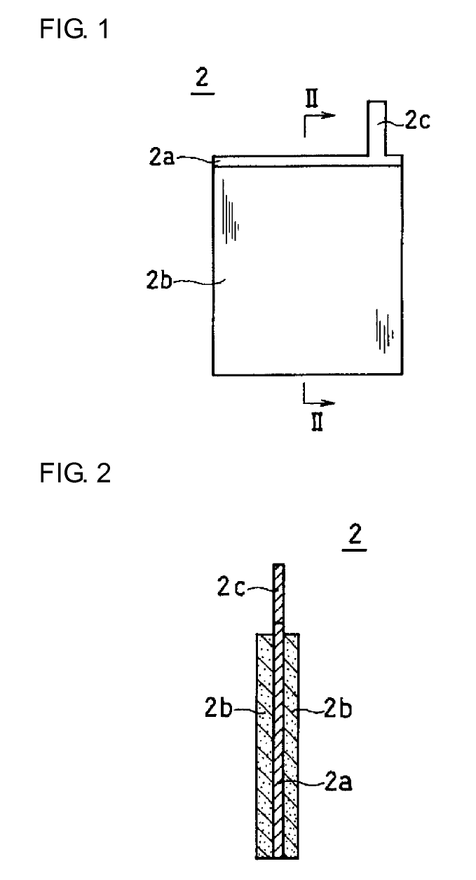

FIG. 1 is a front view of a positive electrode according to an embodiment of the present invention. FIG. 2 is a cross-sectional view taken along line II-II in FIG. 1.

A positive electrode 2 for a sodium molten-salt battery includes a positive electrode current collector 2a and a positive electrode active material layer 2b adhering to the positive electrode current collector 2a. The positive electrode active material layer 2b contains, as an essential component, a positive electrode active material and may contain, as optional components, a conductive carbon material, a binder, etc.

As the positive electrode active material, sodium-containing metal oxides are preferably used. The sodium-containing metal oxides may be used alone or in combination of a plurality of sodium-containing metal oxides. An average particle size (particle size D50 at which the cumulative value of volume particle size distribution is 50%) of particles of the sodium-containing metal oxide is preferably 2 μm or more and 20 μm or less. The term “average particle size D50” refers to a value measured by a laser diffraction/scattering method using a laser diffraction particle size distribution analyzer, and this also applies hereinafter.

For example, sodium chromite (NaCrO₂) may be used as the sodium-containing metal oxide. Part of Cr or Na of sodium chromite may be replaced with another element. For example, a compound represented by a general formula: Na₁₋ₓM¹ₓCr_{1-y}M²_{y}O₂ (where 0≦x≦⅔, 0≦y≦0.7, and M¹ and M² are each independently a metal element other than Cr and Na) is preferable. In the general formula, x more preferably satisfies 0≦x≦0.5. M¹ and M² are preferably, for example, at least one selected from the group consisting of Ni, Co, Mn, Fe, and Al. Note that M¹ represents an element occupying the Na site, and M² represents an element occupying the Cr site.

Sodium ferromanganate (Na_{2/3}Fe_{1/3}Mn_{2/3}O₂ or the like) may also be used as the sodium-containing metal oxide. Part of Fe, Mn, or Na of sodium ferromanganate may be replaced with another element. For example, a compound represented by a general formula: Na_{2/3-x}M³ₓFe_{1/3-y}Mn_{2/3-z}M⁴_{y+z}O₂ (where 0≦x≦⅔, 0≦y≦⅓, 0≦z≦⅓, and M³ and M⁴ are each independently a metal element other than Fe, Mn, and Na) is preferable. In the general formula, x more preferably satisfies 0≦x≦⅓. M³ is preferably, for example, at least one selected from the group consisting of Ni, Co, and A1. M⁴ is preferably at least one selected from the group consisting of Ni, Co, and A1. Note that M³ represents an element occupying the Na site, and M⁴ represents an element occupying the Fe or Mn site.

Furthermore, Na₂FePO₄F, NaVPO₄F, NaCoPO₄, NaNiPO₄, NaMnPO₄, NaMn_{1.5}Ni_{0.5}O₄, NaMn_{0.5}Ni_{0.5}O₂, etc. may be used as the sodium-containing metal oxides.

Examples of the conductive carbon material incorporated in the positive electrode include graphite, carbon black, and carbon fibers. The conductive carbon material easily ensures a good conduction path. However, the conductive carbon material may cause side reactions with sodium carbonate remaining in the positive electrode active material. However, in the present invention, since the amount of remaining sodium carbonate is significantly reduced, good electrical conductivity can be ensured while sufficiently suppressing side reactions. Among the conductive carbon materials, carbon black is particularly preferable from a viewpoint that a sufficient conduction path can be easily formed by use of a small amount. Examples of carbon black include acetylene black, Ketjen black, and thermal black.

The amount of conductive carbon material is 2 to 15 parts by mass, and more preferably 3 to 8 parts by mass per 100 parts by mass of the positive electrode active material.

The binder has a function of binding positive electrode active materials to one another and fixing the positive electrode active materials to a positive electrode current collector. Examples of the binder that can be used include fluororesins, polyamides, polyimides, and polyamide-imides. Examples of the fluororesins that can be used include polyvinylidene fluoride (PVDF), polytetrafluoroethylene (PTFE), tetrafluoroethylene-hexafluoropropylene copolymers, and vinylidene fluoride-hexafluoropropylene copolymers. The amount of binder is preferably 1 to 10 parts by mass, and more preferably 3 to 5 parts by mass per 100 parts by mass of the positive electrode active material.

As the positive electrode current collector 2a, a metal foil, a non-woven fabric made of metal fibers, a porous metal sheet, or the like is used. As the metal constituting the positive electrode current collector, aluminum or an aluminum alloy is preferable because it is stable at the positive electrode potential. However, the metal is not particularly limited thereto. In the case where an aluminum alloy is used, the content of a metal component (for example, Fe, Si, Ni, or Mn) other than aluminum is preferably 0.5% by mass or less. The metal foil serving as the positive electrode current collector has a thickness of, for example, 10 to 50 μm. The non-woven fabric made of metal fibers or the porous metal sheet serving as the positive electrode current collector has a thickness of, for example, 100 to 600 μm. A lead piece 2c for current collection may be formed on the positive electrode current collector 2a. The lead piece 2c may be integrally formed with the positive electrode current collector as illustrated in FIG. 1. Alternatively, a lead piece that is separately formed may be joined to the positive electrode current collector by welding or the like.

### [Negative Electrode]

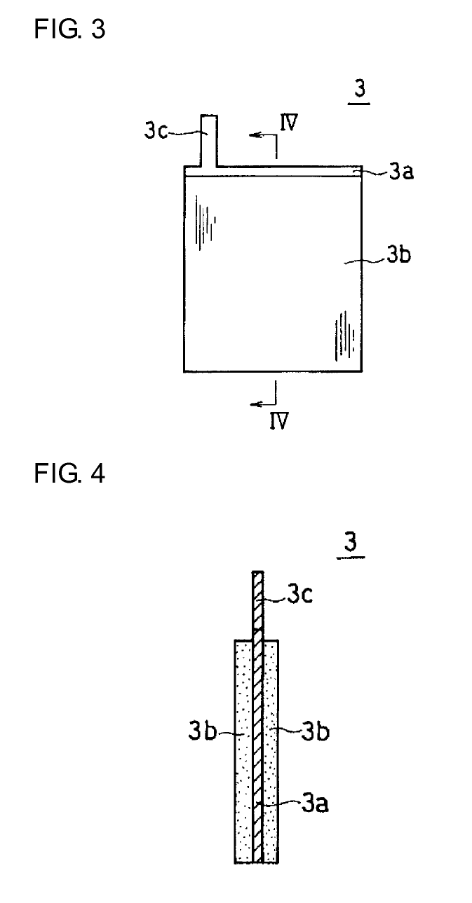

FIG. 3 is a front view of a negative electrode according to an embodiment of the present invention. FIG. 4 is a cross-sectional view taken along line IV-IV in FIG. 3.

A negative electrode 3 includes a negative electrode current collector 3a and a negative electrode active material layer 3b adhering to the negative electrode current collector 3a.

For example, metallic sodium, a sodium alloy, or a metal that alloys with sodium can be used as the negative electrode active material layer 3b. The negative electrode includes, for example, a negative electrode current collector composed of a first metal, and a second metal that covers at least a part of a surface of the negative electrode current collector. The first metal is a metal that does not alloy with sodium. The second metal is a metal that alloys with sodium.

As the negative electrode current collector composed of the first metal, a metal foil, a non-woven fabric made of metal fibers, a porous metal sheet, or the like is used. As the first metal, for example, aluminum, an aluminum alloy, copper, a copper alloy, nickel, or a nickel alloy is preferable because it does not alloy with sodium and is stable at the negative electrode potential. Among these, aluminum or an aluminum alloy is preferable in terms of good lightweight property. For example, aluminum alloys the same as those exemplified for the positive electrode current collector may be used as the aluminum alloy. The metal foil serving as the negative electrode current collector has a thickness of, for example, 10 to 50 μm. The non-woven fabric made of metal fibers or the porous metal sheet serving as the negative electrode current collector has a thickness of, for example, 100 to 600 μm. A lead piece 3c for current collection may be formed on the negative electrode current collector 3a. The lead piece 3c may be integrally formed with the negative electrode current collector as illustrated in FIG. 3. Alternatively, a lead piece that is separately formed may be joined to the negative electrode current collector by welding or the like.

Examples of the second metal include zinc, zinc alloys, tin, tin alloys, silicon, and silicon alloys. Among these, zinc or a zinc alloy is preferable from the viewpoint of good wettability to a molten salt. The negative electrode active material layer formed of the second metal suitably has a thickness of, for example, 0.05 to 1 μm. In a zinc alloy or a tin alloy, the content of a metal component (for example, Fe, Ni, Si, or Mn) other than zinc or tin is preferably 0.5% by mass or less.

An example of a preferred embodiment of the negative electrode includes a negative electrode including a negative electrode current collector formed of aluminum or an aluminum alloy (first metal), and zinc, a zinc alloy, tin, or a tin alloy (second metal) that covers at least a part of a surface of the negative electrode current collector. This negative electrode has a high capacity and does not easily degrade for a long period of time.

The negative electrode active material layer composed of the second metal can be obtained by, for example, attaching or compression-bonding a sheet of a second metal to the negative electrode current collector. Alternatively, the second metal may be caused to adhere to the negative electrode current collector by gasifying the second metal by a gas-phase method such as a vacuum deposition method or a sputtering method. Alternatively, fine particles of the second metal may be caused to adhere to the negative electrode current collector by an electrochemical method such as a plating method. A thin, uniform, negative electrode active material layer can be formed by a gas-phase method or a plating method.

The negative electrode active material layer 3b may be a mixture layer containing, as an essential component, a negative electrode active material that electrochemically intercalates and deintercalates sodium ions and, as optional components, a binder, a conductive material, etc. The materials exemplified for components of the positive electrode may be used as the binder and the conductive material used in the negative electrode. The amount of binder is preferably 1 to 10 parts by mass, and more preferably 3 to 5 parts by mass per 100 parts by mass of the negative electrode active material. The amount of conductive material is preferably 5 to 15 parts by mass, and more preferably 5 to 10 parts by mass per 100 parts by mass of the negative electrode active material.

As the negative electrode active material that electrochemically intercalates and deintercalates sodium ions, for example, sodium-containing titanium compounds and non-graphitizable carbon (hard carbon) are preferably used from the viewpoint of thermal stability and electrochemical stability. As the sodium-containing titanium compound, sodium titanate is preferable. More specifically, at least one selected from the group consisting of Na₂Ti₃O₇ and Na₄Ti₅O₁₂ is preferably used. Part of Ti or Na of sodium titanate may be replaced with another element. For example, it is possible to use Na₂₋ₓM⁵ₓTi_{3-y}M⁶_{y}O₇ (where 0≦x≦3/2, 0≦y≦8/3, and M⁵ and M⁶ are each independently a metal element other than Ti and Na, and for example, at least one selected from the group consisting of Ni, Co, Mn, Fe, Al, and Cr), Na₄₋ₓM⁷ₓTi_{5-y}M⁸_{y}O₁₂ (where 0≦x≦11/3, 0≦y≦14/3, and M⁷ and M⁸ are each independently a metal element other than Ti and Na, and for example, at least one selected from the group consisting of Ni, Co, Mn, Fe, Al, and Cr), and the like. The sodium-containing titanium compounds may be used alone or in combination of a plurality of compounds. The sodium-containing titanium compound may be used in combination with non-graphitizable carbon. Note that M⁵ and M⁷ each represent an element occupying the Na site, and M⁶ and M⁸ each represent an element occupying the Ti site.

Non-graphitizable carbon is a carbon material in which a graphite structure is not developed even when the material is heated in an inert atmosphere, and in which minute graphite crystals are arranged in random directions, and there are nanometer-order spaces between crystal layers. Since the diameter of an ion of sodium, which is a typical alkali metal, is 0.95 Å, the size of the spaces is preferably sufficiently larger than this value. The average particle size (particle size D50 at which the cumulative value of volume particle size distribution is 50%) of non-graphitizable carbon is, for example, 3 to 20 μm, and preferably 5 to 15 μm from the viewpoint of enhancing the filling property of the negative electrode active material in the negative electrode and suppressing side reactions with the electrolyte (molten salt). Furthermore, the specific surface area of non-graphitizable carbon is, for example, 1 to 10 m²/g, and preferably 3 to 8 m²/g from the viewpoint of ensuring the acceptability of sodium ions and suppressing side reactions with the electrolyte. The non-graphitizable carbons may be used alone or in combination of a plurality of non-graphitizable carbon.

### [Separator]

A separator may be disposed between the positive electrode and the negative electrode. The material of the separator can be selected in consideration of the operating temperature of the battery. From the viewpoint of suppressing side reactions with molten-salt electrolytes, glass fibers, silica-containing polyolefins, fluororesins, alumina, polyphenylene sulfide (PPS), and the like are preferably used. Among these, a non-woven fabric made of glass fibers is preferable from the viewpoint of a low cost and high heat resistance. Silica-containing polyolefins and alumina are preferable from the viewpoint of good heat resistance. Fluororesins and PPS are preferable from the viewpoint of heat resistance and corrosion resistance. In particular, PPS has good resistance to fluorine contained in a molten salt.

The thickness of the separator is preferably 10 to 500 μm, and more preferably 20 to 50 μm. This is because when the thickness is in this range, internal short-circuit can be effectively prevented, and the volume occupancy ratio of the separator to an electrode group can be suppressed to be low and thus a high capacity density can be achieved.

### [Electrode Group]

A sodium molten-salt battery is used in a state in which an electrode group including the positive electrode and the negative electrode, and a molten-salt electrolyte are housed in a battery case. The electrode group is formed by stacking or winding the positive electrode and the negative electrode with a separator interposed therebetween. In this structure, by using a metal battery case and electrically connecting one of the positive electrode and the negative electrode to the battery case, a portion of the battery case can be used as a first external terminal. On the other hand, the other of the positive electrode and the negative electrode is connected, through a lead piece or the like, to a second external terminal which is led to the outside of the battery case in a state of being insulated from the battery case.

Next, a structure of a sodium molten-salt battery according to an embodiment of the present invention will be described. However, it is to be noted that the structure of the sodium molten-salt battery according to the present invention is not limited to the structure described below.

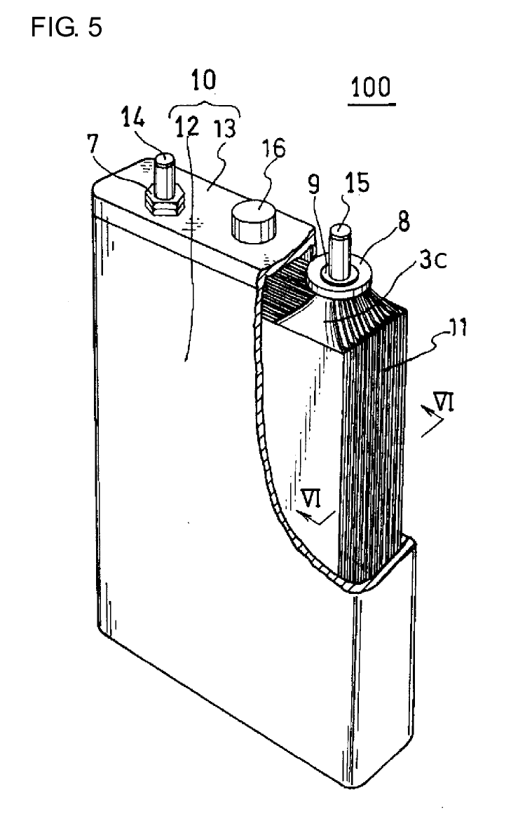

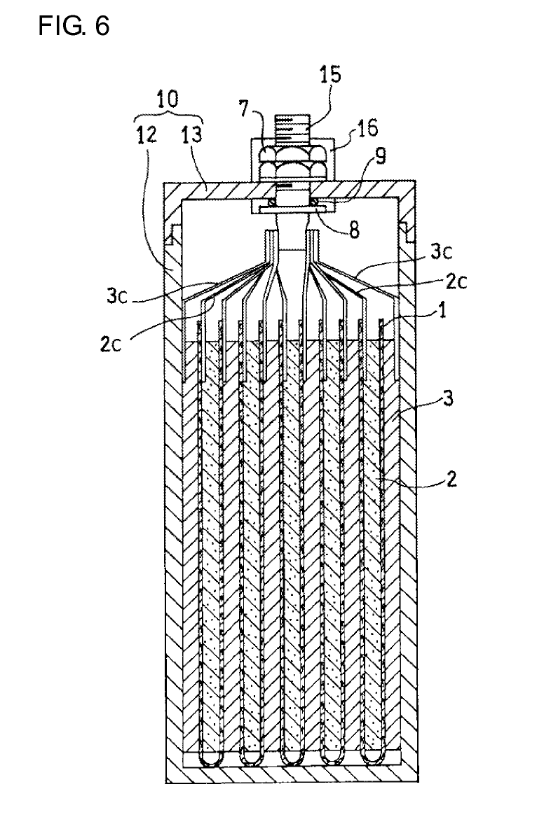

FIG. 5 is a perspective view of a sodium molten-salt battery 100, in which a battery case is partially cut out. FIG. 6 is a schematic longitudinal cross-sectional view taken along the line VI-VI in FIG. 5.

A molten-salt battery 100 includes a stack-type electrode group 11, an electrolyte (not shown), and a rectangular-shaped aluminum battery case 10 which houses these components. The battery case 10 includes a container body 12 having an opening on the top and a closed bottom, and a lid 13 which covers the opening on the top. When the molten-salt battery 100 is assembled, first, the electrode group 11 is formed and inserted into the container body 12 of the battery case 10. Subsequently, a process is performed in which a molten-salt electrolyte is poured into the container body 12, and spaces between a separator 1, a positive electrode 2, and a negative electrode 3 constituting the electrode group 11 are impregnated with the molten-salt electrolyte. Alternatively, after the electrode group is impregnated with the molten-salt electrolyte, the electrode group containing the molten-salt electrolyte may be housed in the container body 12.

An external positive electrode terminal 14 is provided on the lid 13 at a position close to one side, the external positive electrode terminal 14 passing through the lid 13 while being electrically connected to the battery case 10. An external negative electrode terminal 15 is provided on the lid 13 at a position close to the other side, the external negative electrode terminal 15 passing through the lid 13 while being insulated from the battery case 10. A safety valve 16 is provided in the center of the lid 13 for the purpose of releasing gas generated inside when the internal pressure of the battery case 10 increases.

The stack-type electrode group 11 includes a plurality of positive electrodes 2, a plurality of negative electrodes 3, and a plurality of separators 1 interposed therebetween, each having a rectangular sheet shape. In FIG. 6, the separator 1 is formed like a bag so as to enclose the positive electrode 2. However, the form of the separator is not particularly limited. The plurality of positive electrodes 2 and the plurality of negative electrodes 3 are alternately arranged in the stacking direction in the electrode group 11.

A positive electrode lead piece 2c may be formed on one end of each positive electrode 2. By bundling the positive electrode lead pieces 2c of the positive electrodes 2 and connecting the bundle to the external positive electrode terminal 14 provided on the lid 13 of the battery case 10, the positive electrodes 2 are connected in parallel. Similarly, a negative electrode lead piece 3c may be formed on one end of each negative electrode 3. By bundling the negative electrode lead pieces 3c of the negative electrodes 3 and connecting the bundle to the external negative electrode terminal 15 provided on the lid 13 of the battery case 10, the negative electrodes 3 are connected in parallel. The bundle of the positive electrode lead pieces 2c and the bundle of the negative electrode lead pieces 3c are desirably arranged on the right and left sides of one end face of the electrode group 11 with a distance therebetween so as not to be in contact with each other.

Each of the external positive electrode terminal 14 and the external negative electrode terminal 15 is columnar and is provided with a thread groove at least on a portion exposed to the outside. A nut 7 is fit into the thread groove of each terminal. By rotating the nut 7, the nut 7 is fixed to the lid 13. A flange 8 is provided on a portion of each terminal to be housed in the battery case. The flange 8 is fixed to the inner surface of the lid 13 with a washer 9 therebetween by the rotation of the nut 7.

### EXAMPLES

Next, the present invention will be described more specifically on the basis of Examples. However, it is to be understood that the present invention is not limited to the Examples below.

### Example 1

### Fabrication of Positive Electrode

A positive electrode paste was prepared by dispersing 85 parts by mass of NaCrO₂ (positive electrode active material) having an average particle size of 10 μm, 10 parts by mass of acetylene black (conductive carbon material), and 5 parts by mass of PVDF (binder) in N-methyl-2-pyrrolidone (NMP) serving as a dispersion medium. The resulting positive electrode paste was applied onto one surface of an aluminum foil having a thickness of 20 μm, dried, subjected to rolling, and cut into predetermined dimensions. Thus, a positive electrode including a positive electrode active material layer having a thickness of 80 μm was fabricated. The positive electrode was punched into a coin shape having a diameter of 12 mm.

### (Fabrication of Negative Electrode)

Metallic sodium having a thickness of 100 μm was attached to one surface of an aluminum foil having a thickness of 20 μm to fabricate a negative electrode. The negative electrode was punched into a coin shape having a diameter of 14 mm.

### (Separator)

A polyolefin separator having a thickness of 50 μm and a porosity of 90% was prepared. The separator was also punched into a coin shape having a diameter of 16 mm.

### (Molten-Salt Electrolyte)

A molten-salt electrolyte A1 composed of a mixture of commercially available sodium.bis(fluorosulfonyl)imide (Na.FSI: sodium salt) and commercially available 1-methyl-1-propylpyrrolidinium.bis(fluorosulfonyl)imide (MPPY.FSI: ionic liquid) at a molar ratio of 10:90 was prepared.

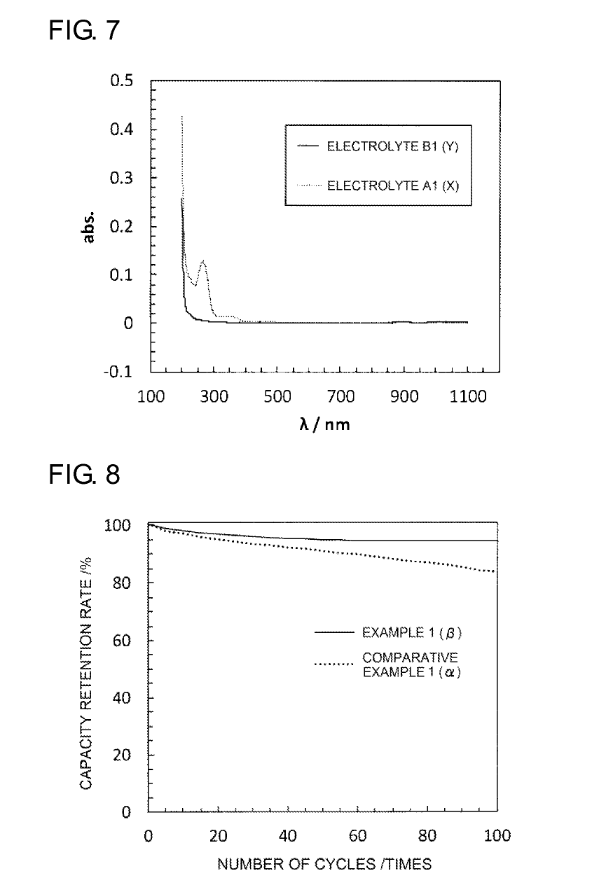

Impurities of the molten-salt electrolyte A1 were examined by ICP, ion chromatography, IR analysis, and NMR analysis. According to the results, the presence of impurities was not confirmed. On the other hand, according to the result of a measurement of a UV-Vis absorption spectrum of the molten-salt electrolyte A1, a clear peak attributable to impurities was observed in the wavelength range of 200 to 500 nm, though the intensity thereof was weak. FIG. 7 shows the UV-Vis absorption spectrum (graph X) of the molten-salt electrolyte A1.

Next, the MPPY.FSI was purified by passing through a column filled with activated alumina and then mixed with Na.FSI. Thus, a molten-salt electrolyte B1 composed of a mixture of MPPY.FSI and Na.FSI at a molar ratio of 90:10 was prepared.

According to the result of a measurement of a UV-Vis absorption spectrum of the molten-salt electrolyte B1, the peak in the wavelength range of 200 to 500 nm observed in the UV-Vis absorption spectrum of the molten-salt electrolyte A1 disappeared completely. FIG. 7 shows the UV-Vis absorption spectrum (graph Y) of the molten-salt electrolyte B1.

### (Fabrication of Sodium Molten-Salt Battery)

The positive electrode, the negative electrode, and the separator were dried sufficiently by heating at 90° C. or higher at a reduced pressure of 0.3 Pa. Subsequently, the coin-shaped positive electrode was placed in a shallow, cylindrical container composed of a SUS/A1 cladding material. The coin-shaped negative electrode was placed on the positive electrode with the separator therebetween. A predetermined amount of the molten-salt electrolyte B1 was poured into the container. The opening of the container was then sealed with a shallow, cylindrical, sealing plate that was composed of SUS and provided with an insulation gasket on the periphery thereof. In this manner, a pressure was applied to an electrode group including the positive electrode, the separator, and the negative electrode between the bottom surface of the container and the sealing plate, thereby ensuring a contact between the components. Thus, a coin-type sodium molten-salt battery B1 having a designed capacity of 1.5 mAh was fabricated.

### Comparative Example 1

A coin-type sodium molten-salt battery A1 was fabricated as in Example 1 except that the molten-salt electrolyte A1 was used instead of the molten-salt electrolyte B1.

### [Evaluation 1]

The sodium molten-salt batteries of Example 1 and Comparative Example 1 were heated to 90° C. in a thermostatic chamber. In a state in which the temperature was stabilized, 100 cycles of charging and discharging were performed in which the conditions of (1) to (3) below were defined as one cycle. A ratio of the discharge capacity (capacity retention rate) of the 50th cycle or the 100th cycle to the discharge capacity of the first cycle was determined.

(1) Charging at a charging current of 0.2 C up to a charging termination voltage of 3.5 V

(2) Charging at a constant voltage of 3.5 V up to a termination current of 0.01 C

(3) Discharging at a discharging current of 0.2 C down to a discharging termination voltage of 2.5 V

Table I shows the results of the capacity retention rate. FIG. 8 shows the relationship (graph β) between the number of charge-discharge cycles and the capacity retention rate of the battery B1 of Example 1, and the relationship (graph α) between the number of charge-discharge cycles and the capacity retention rate of the battery A1 of Comparative Example 1.

TABLE I

Capacity retention rate (%)

| | Example 1 | Comparative example 1 |
|---|---|---|
| Number of cycles | (Battery B1) | (Battery A1) |
| 50 | 95 | 91 |
| 100 | 94 | 84 |

Referring to FIGS. 7 and 8 and Table I, it is understood that the presence or absence of an absorption peak in the wavelength range of 200 to 500 nm of the UV-Vis absorption spectrum of the molten-salt electrolyte causes a significant difference in capacity retention rate.

### Example 2

A molten-salt electrolyte A2 composed of a mixture of commercially available sodium.bis(trifluoromethylsulfonyl)imide (Na.TFSI: sodium salt) and commercially available 1-methyl-1-propylpyrrolidinium.bis(trifluoromethylsulfonyl)imide (MPPY.TFSI: ionic liquid) at a molar ratio of 10:90 was prepared.

Impurities of the molten-salt electrolyte A2 were examined by ICP, ion chromatography, IR analysis, and NMR analysis. According to the results, the presence of impurities was not confirmed. On the other hand, according to the result of a measurement of a UV-Vis absorption spectrum of the molten-salt electrolyte A2, a clear peak attributable to impurities was observed in the wavelength range of 200 to 500 nm, though the intensity thereof was weak.

Next, the MPPY.TFSI was purified by passing through a column filled with activated alumina and then mixed with Na.TFSI. Thus, a molten-salt electrolyte B2 composed of a mixture of MPPY.TFSI and Na.TFSI at a molar ratio of 90:10 was prepared.

According to the result of a measurement of a UV-Vis absorption spectrum of the molten-salt electrolyte B2, the peak in the wavelength range of 200 to 500 nm observed in the UV-Vis absorption spectrum of the molten-salt electrolyte A2 disappeared completely.

A coin-type sodium molten-salt battery B2 was fabricated as in Example 1 except that the molten-salt electrolyte B2 was used instead of the molten-salt electrolyte B1.

### Comparative Example 2

A coin-type sodium molten-salt battery A2 was fabricated as in Example 1 except that the molten-salt electrolyte A2 was used instead of the molten-salt electrolyte B1.

### [Evaluation 2]

Also in Example 2 and Comparative Example 2, the capacity retention rate was measured in the same manner described above. Table II shows the results.

TABLE II

Capacity retention rate (%)

| | Example 2 | Comparative example 2 |
|---|---|---|
| Number of cycles | (Battery B2) | (Battery A2) |
| 50 | 94 | 88 |
| 100 | 93 | 79 |

Referring to Table II, it is understood that the presence or absence of an absorption peak in the wavelength range of 200 to 500 nm of the UV-Vis absorption spectrum of the molten-salt electrolyte causes a significant difference in capacity retention rate.

### Example 3

A molten-salt electrolyte A3 composed of a mixture of commercially available sodium.bis(fluorosulfonyl)imide (Na.FSI: sodium salt) and commercially available 1-methyl-1-butylpyrrolidinium.bis(fluorosulfonyl)imide (MBPY.FSI: ionic liquid) at a molar ratio of 10:90 was prepared.

Impurities of the molten-salt electrolyte A3 were examined by ICP, ion chromatography, IR analysis, and NMR analysis. According to the results, the presence of impurities was not confirmed. On the other hand, according to the result of a measurement of a UV-Vis absorption spectrum of the molten-salt electrolyte A3, a clear peak attributable to impurities was observed in the wavelength range of 200 to 500 nm, though the intensity thereof was weak.

Next, the MBPY.FSI was purified by passing through a column filled with activated alumina and then mixed with Na.FSI. Thus, a molten-salt electrolyte B3 composed of a mixture of MBPY.FSI and Na.FSI at a molar ratio of 90:10 was prepared.

According to the result of a measurement of a UV-Vis absorption spectrum of the molten-salt electrolyte B3, the peak in the wavelength range of 200 to 500 nm observed in the UV-Vis absorption spectrum of the molten-salt electrolyte A3 disappeared completely.

A coin-type sodium molten-salt battery B3 was fabricated as in Example 1 except that the molten-salt electrolyte B3 was used instead of the molten-salt electrolyte B1.

### Comparative Example 3

A coin-type sodium molten-salt battery A3 was fabricated as in Example 1 except that the molten-salt electrolyte A3 was used instead of the molten-salt electrolyte B1.

### [Evaluation 3]

Also in Example 3 and Comparative Example 3, the capacity retention rate was measured in the same manner described above. Table III shows the results.

TABLE III

Capacity retention rate (%)

| | Example 3 | Comparative example 3 |
|---|---|---|
| Number of cycles | (Battery B3) | (Battery A3) |
| 50 | 96 | 91 |
| 100 | 95 | 85 |

Referring to Table III, it is understood that the presence or absence of an absorption peak in the wavelength range of 200 to 500 nm of the UV-Vis absorption spectrum of the molten-salt electrolyte causes a significant difference in capacity retention rate.

### INDUSTRIAL APPLICABILITY

The sodium molten-salt battery according to the present invention has good charge-discharge cycle characteristics. Therefore, the sodium molten-salt battery according to the present invention is useful in applications in which long-term reliability is required, for example, as a large-scale power storage device for household or industrial use and a power source for electric cars and hybrid cars.

### REFERENCE SIGNS LIST

1: separator, 2: positive electrode, 2a: positive electrode current collector, 2b: positive electrode active material layer, 2c: positive electrode lead piece, 3: negative electrode, 3a: negative electrode current collector, 3b: negative electrode active material layer, 3c: negative electrode lead piece, 7: nut, 8: flange, 9: washer, 10: battery case, 11: electrode group, 12: container body, 13: lid, 14: external positive electrode terminal, 15: external negative electrode terminal, 16: safety valve, 100: molten-salt battery

1. A molten-salt electrolyte comprising an ionic liquid whose ultraviolet-visible absorption spectrum does not have an absorption peak attributable to impurities in a wavelength range of 200 nm or more and 500 nm or less; and a sodium salt.

2. The molten-salt electrolyte according to claim 1, wherein the ionic liquid is a salt of an organic onium cation and a bis(sulfonyl)imide anion.

3. The molten-salt electrolyte according to claim 2, wherein the organic onium cation has a nitrogen-containing heterocycle.

4. The molten-salt electrolyte according to claim 3, wherein the nitrogen-containing heterocycle has a pyrrolidine skeleton.

5. The molten-salt electrolyte according to claim 1, wherein the sodium salt is a salt of a sodium ion and a bis(sulfonyl)imide anion.

6. A sodium molten-salt battery comprising a positive electrode that contains a positive electrode active material; a negative electrode that contains a negative electrode active material; and the molten-salt electrolyte according to claim 1.
